(19) United States
(12) Patent Application Publication
(10) Pub. No.: US 2024/0430947 A1
(43) Pub. Date: Dec. 26, 2024

(54) APPARATUS AND METHOD FOR INCREASING REACH AREA OF RANDOM ACCESS PREAMBLE AND UPLINK DATA SIGNALS IN WIRELESS COMMUNICATION SYSTEM

(71) Applicant: ELECTRONICS AND TELECOMMUNICATIONS RESEARCH INSTITUTE, Daejeon (KR)

(72) Inventors: Chanho YOON, Daejeon (KR); Cheulsoon KIM, Daejeon (KR); Young Jo KO, Daejeon (KR); Yong Sun KIM, Daejeon (KR); Kapseok CHANG, Daejeon (KR)

(21) Appl. No.: 18/752,623

(22) Filed: Jun. 24, 2024

(30) Foreign Application Priority Data
Jun. 23, 2023 (KR) 10-2023-0081317
Nov. 8, 2023 (KR) 10-2023-0153796
Jun. 10, 2024 (KR) 10-2024-0075164

(51) Int. Cl. H04W 74/0833; H04L 27/26

(52) U.S. Cl. CPC H04W 74/0833; H04L 27/2614

(57) ABSTRACT

Proposed is an apparatus and method for increasing the reach area of a random access preamble and uplink data signals in a wireless communication system. An operation method of a transmitter in a wireless communication system may include a process of generating sequences for generating a physical random preamble channel (PRACH) signal, a process of converting the sequences in a frequency domain, a process of dividing the converted sequences into frequency source blocks (RB), a process of allocating the frequency resource blocks to different spatial layers, and a process of transmitting the PRACH signal on the basis of the frequency resource blocks allocated to the spatial layers.

### CROSS REFERENCE TO RELATED APPLICATION

The present application claims priority to Korean Patent Applications No. 10-2023-0081317, filed Jun. 23, 2023, 10-2023-0153796, filed Nov. 8, 2023, and 10-2024-0075164 filed Jun. 10, 2024, the entire contents of which are incorporated herein for all purposes by this reference.

### BACKGROUND

### Technical Field

The present disclosure generally relates to a wireless communication system and, more particularly, an apparatus and method for increasing the reach area of a random access preamble and uplink data signals in a wireless communication system.

### Description of the Related Art

In order to perform RCC connection and scheduling-based data communication in 4G long term evolution (LTE) and 5G new radio (NR), user equipment (UE) decodes a synchronizing signal that a base station (BS) periodically transmits, and obtains various items of information for connecting to the wireless network of the base station on the basis of the content of the signal. In particular, when directional transmit beamforming is performed for each space by performing a repetitive transmission pattern within a predetermined temporal duration of a synchronizing signal, such as 5G NR, a terminal should transmit a random access preamble, which corresponds to a specific beam direction of a synchronizing signal that a base station periodically and repeatedly transmits, in a RACH transmission type. Further, the terminal transmits preambles to the base station for not only a beam of a specific direction designated by the base station, but places where specific time and frequency resources are allocated. The base station performs a mechanism that recognizes an attempt to connect through four-step and two-step procedures of random access.

However, a wireless signal can reach a receiver through a wireless channel with a low signal to noise ratio due to attenuation of a radio signal by fading, path-loss, and formation of a destructive beam. In particular, when the power of transmission power is limited like a mobile terminal, an effective boundary or limitation is unavoidably formed for a coverage due to the feature of a wireless channel described above and a physical distance difference when a random access (RA) preamble signal for the terminal to connect to a base station reaches to the base station. Accordingly, it is possible to increase a coverage by allocating a lot of time and frequency resources, but it means that resources are used that much, which causes the defect that the resource or frequency efficiency decreases.

In particular, the structure of a PRACH signal has to support UE having low capability and a terminal having limited transmission antenna ports (e.g., one transmission port). In order to be able to reduce a false detection rate without increasing the number of varieties to increase a determination probability after detecting the kind of a preamble, assuming a single port transmission increases the accuracy of the detection probability rather than assuming multiple transmission ports. Accordingly, a space time block code and a spatial extension technology such as spatial multiplexing are applied, the number of cases that should be considered in detection increases, so the probability of successful detection and accurate identification of a preamble decreases, whereby it is difficult to apply a spatial coding technique. Accordingly, limitation of the coverage of a random access preamble signal is involved in deterioration of the efficiency and transmission reliability of a wireless network, and, in order to overcome this problem, there is a need for a method of improving the issue even without adding specific time and frequency resources. In particular, temporal retransmission causes an increase in power consumption of terminals that are operated by batteries, so it may not be preferable.

However, in spite of an increase in power consumption described above, when it is impossible to extend a coverage using a spatial technique due to the structure of a terminal, it is possible to extend the coverage of a RPACH signal by performing PRACH transmission multiple times. However, PRACH transmission is applied several time, a base station has to determine whether a terminal has attempted PRACH transmission only once or has attempted to connect through multiple transmission. In particular, a base station has to be able to simultaneously detect PRACH signals that are simultaneously input in specific time and frequency domains (i.e., simultaneously transmitted from several terminals), so the base station needs rules for clear determination.

Further, a coverage may be limited due to the characteristic of a wireless channel described above even though data is transmitted through a PUSCH even after a terminal succeeds in connecting. When binary data is decoded like a PUSCH uplink data signal, it is possible to reduce deterioration of performance due to fading of a wireless channel by combining multiple antennas and a channel coding technology, but a coverage may be limited by back-off of transmission power due to the characteristics of modulated signals (waveforms) Factors that act as obstructions in a coverage and reliability after an NR standard is deployed may be the waveform of a physical uplink shared channel (PUSCH) of an uplink. In particular, FR2 of the usage scenario of NR assumes very dense small cell deployment of a base station. That is, since it is assumed that the physical distance between a terminal and a base station is close statistically or on average, a waveform suitable for the case in which it is possible to advantageously secure an SNR like OFDMA is considered as a default mode of an uplink. However, the phase distance between a base station and a terminal is not always close in deployment scenarios, and in FR2, phase noise remarkably increases due to the characteristics of an RF element and an increase in sensitivity due to a frequency, timing offset, jitter, and Doppler spread is remarkable, so performance is basically significantly deteriorated in comparison to an FR1 domain when an OFDM waveform is applied. Further, when an OFDMA waveform is applied, it is difficult to secure an SNR of a receiver of a base station due to an additional limitation in transmission power of a terminal due to a high peak-to-average power ratio (PAPR), so a coverage is limited. Accordingly, when DFT-s-OFDM of a single carrier type is applied, the influence (particularly, phase noise) by the RF impairment described above decreases and it is possible to reduce the amount of power back-off of additional transmission power limitation due to a waveform having a low PAPR characteristic in comparison to OFDM, so it is possible to increase a coverage and improve reliability by further securing an SNR of a base station. In particular, when the influence by RF impairment decreases in an FR2 frequency band, it is possible to expect to increase the coverage of a PUSCH channel and improve the reliability thereof.

NR supports a DFT-s-OFDM waveform, but modulation orders (QPSK, 16-QAM, 256-QAM, etc.) increase, so the PAPR greatly increases. In particular, modulation orders of QPSK or more to pi/2-BPSK modulation that is supported by NR have a slightly high PAPR, there is a need for a method that can increase a coverage and obtain reliability by additionally reducing the PAPR. Further, there is a need for a method that is effective in higher order modulation to which a PAPR reduction effect cannot be applied in the way of applying phase rotation of continuous symbols like the pi/2-BPSK type.

### SUMMARY

Based on the matters described above, the present disclosure relates to an apparatus and method for increasing the reach area of a random access preamble and uplink data signals in a wireless communication system.

Further, the present disclosure provides an apparatus and method for increasing a reach distance of a transmission signal that is transmitted from user equipment (UE) by using a space without adding time and frequency resources in a wireless communication system.

Further, the present disclosure provides an apparatus and method for increasing a reach distance of a transmission signal without adding a transmission procedure while maintaining compatibility with an existing cellular system in a wireless communication system.

Further, the present disclosure provides an apparatus and method for allocating random access support in order to increase a reach area by performing transmission multiple times in a time domain in a wireless communication system.

Further, the present disclosure provides an apparatus and method for increasing a reach distance of an uplink data signal when transmitting an uplink data signal after random access in a wireless communication system.

According to various embodiments of the present disclosure, an operation method of a transmitter in a wireless communication system includes: a process of generating sequences for generating a physical random preamble channel (PRACH) signal; a process of converting the sequences in a frequency domain; a process of dividing the converted sequences into frequency source blocks (RB); a process of allocating the frequency resource blocks to different spatial layers, and a process of transmitting the PRACH signal on the basis of the frequency resource blocks allocated to the spatial layers.

According to various embodiments of the present disclosure, an operation method of a transmitter in a wireless communication system includes: a process of applying a spectrum shaping filter to a physical uplink shared channel (PUSCH) signal in a frequency domain; a process of reducing a peak-to-average power ratio (PAPR) by filtering the PUSCH signal through a finite impulse response (FIR) filter in a time domain; and a process of transmitting the FIR-filtered PUSCH signal.

According to various embodiments of the present disclosure, a transmitter of a wireless communication system includes: a transceiver; and a control unit operably connected to the transceiver, in which the control unit generates sequences for generating a physical random preamble channel (PRACH) signal, converts the sequences in a frequency domain, divides the converted sequences into frequency source blocks (RB), allocates the frequency resource blocks to different spatial layers, and transmits the PRACH signal on the basis of the frequency resource blocks allocated to the spatial layers.

According to various embodiments of the present disclosure, a transmitter of a wireless communication system includes: a transceiver; and a control unit operably connected to the transceiver, in which the transmitter applies a spectrum shaping filter to a physical uplink shared channel (PUSCH) signal in a frequency domain, reduces a peak-to-average power ratio (PAPR) by filtering the PUSCH signal through a finite impulse response (FIR) filter in a time domain, and transmits the FIR-filtered PUSCH signal.

An apparatus and method according to various embodiment of the present disclosure extends the reach distance of a PRACH signal that is an initial uplink signal that is transmitted when a terminal initially connects to a base station, thereby being able to improve transmission reliability and having compatibility with a legacy communication system.

The effects of the disclosure are not limited to the effects described above and other effects can be clearly understood by those skilled in the art from the following description.

### BRIEF DESCRIPTION OF THE DRAWINGS

FIG. 1 shows a random access procedure according to various embodiments of the disclosure;

FIG. 2 is a block diagram showing a transmission end of a terminal according to an embodiment of the present disclosure;

FIG. 3 shows an example of resource allocation relating to mapping of an SSB beam index and an R0 resource designated to transmit multiple PRACHs in accordance with an embodiment of the present disclosure;

FIG. 4 shows another example of resource allocation relating to mapping of an SSB beam index and an R0 resource designated to transmit multiple PRACHs in accordance with an embodiment of the present disclosure;

FIG. 5 shows an example of resource allocation for extending a reach area of a PUSCH in accordance with an embodiment of the present disclosure;

FIG. 6 shows an example of a block diagram for spectrum shaping according to an embodiment of the present disclosure;

FIG. 7 shows another example of a block diagram for spectrum shaping according to an embodiment of the present disclosure;

FIG. 8 is a configuration diagram of a base station in a wireless communication system according to various embodiments of the disclosure; and

FIG. 9 is a configuration diagram of a terminal in a wireless communication system according to various embodiments of the disclosure.

### DETAILED DESCRIPTION

Terminologies used in the present disclosure may be used only to describe specific embodiments without intention of limiting the range of other embodiments. Singular forms are intended to include plural forms unless the context clearly indicates otherwise. All terminologies including technological or scientific used herein terminologies may have the same meanings that are generally understood by those skilled in the art. Terminologies defined in general dictionaries of the terminologies used herein may be understood as having meanings the same as or similar to the meanings in the contexts and should not be construed as abnormally or exclusively formally meanings unless specifically defined herein. Depending on cases, even if terminologies are defined herein, they should not be construed as excluding the embodiments of the present disclosure.

Various embodiments of the present disclosure to be described hereafter are described through examples of hardware approaches. However, since various embodiments of the present disclosure include a technology that uses both hardware and software, various embodiments of the present disclosure do not exclude approaches based of software.

Further, in the specific description and claims of the present disclosure, “at least one of A, B, and C” may mean “only A”, “only B”, “only C”, or “any combination of A, B, and C”. Further, “at least one of A, B, or C” or “at least one of A, B, and/or C” may mean “at least one of A, B, and C”.

Hereafter, the present disclosure relates to an apparatus and method for increasing the reach area of a random access preamble and uplink data signals in a wireless communication system. In detail, the present disclosure relates to uplink transmission in a physical layer of a wireless communication system and describes a technology for extending a reach area of a PRACH signal that is transmitted to connect to a base station and for transmitting an uplink data signal PUSCH signal by changing a modulated signal and changing a transmission procedure in an apparatus based on multi-antenna panels and ports.

In the following description, terms indicating signals, terms indicating channels, terms indicating control information, terms indicating network entities, terms indicating components of an apparatus, etc. are exemplified for the convenience of description. Accordingly, the present disclosure is not limited to the terms to be described hereafter and other terms having equivalent meanings may be used.

Further, various embodiments are described herein using the terms, which are used in some communication standards (e.g., 3rd Generation Partnership Project (3GPP)), but they are only examples for description. Various embodiments of the present disclosure may be easily modified to be applied to other communication systems as well.

As an example of a mobile communication system that can be applied to the present disclosure, 3GPP LTE (hereafter, referred to LTE) and New Radio (hereafter, referred to NR) communication systems are briefly described. In the present disclosure “downlink” means communication to a terminal from a next generation nodeB gNB and “uplink” means communication to a gNB from a terminal. A terminal means communication equipment that is carried by a user, and may be referred to as a mobile station (MS), a user terminal (UT (user equipment (UE)), a subscriber station (SS), or a wireless device.

A physical layer that is the first layer based on 3GP wireless network standards provides an information transfer service to upper layers using a physical channel. A physical layer is connected with a medium access control layer that is an upper layer through a transport channel. Data is moved between the medium access control layer and the physical layer. Data is moved through a physical channel between transmission-side and reception-side physical layers. The physical channel uses time and frequency as wireless resources. In detail, the physical channel is modulated in an Orthogonal Frequency Division Multiple Access (OFDMA) type in downlink and is modulated in a Single Carrier Frequency Division Multiple Access (SC-FDMA) or OFDMA type in uplink.

A Medium Access Control (MAC) layer of a second layer provides a service to a Radio Link Control (RLC) layer that is an upper layer through a logical channel. The RLC layer of the second layer support reliable data transmission. The function of the RLC layer may be implemented by a function block in MAC. One cell constituting a base station gNB provides downlink or uplink transmission service to several terminals. Different cells may be configured to provide different bandwidths. As downlink transmission channels transmitting data from a network to a terminal, there are Broadcast channel (BCH) transmitting system information, a Paging Channel (PCH) transmitting a paging message, a downlink Shared Channel (SCH) transmitting user traffic or a control message, etc. Downlink multicast or traffic of a broadcast service or a control message may be transmitted through a downlink SCH, or may be transmitted through a specific downlink Multicast Channel (MCH).

As uplink transmission channels transmitting data from user equipment (UE) to a network, there are a Random Access Channel (RACH) transmitting an initial control message and an uplink Shared Channel (SCH) transmitting user traffic or a control message. As logical channels that are higher channels than a transmission channel and are mapped to the transmission channel, there are a Broadcast Control Channel (BCCH), a Paging Control Channel (PCCH), a Common Control Channel (CCCH), a Multicast Control Channel (MCCH), a Multicast Traffic Channel (MTCH), etc. A random access (RA) procedure in 4G long term evolution (LTE) and 5G NR may be a necessary procedure to all of UE when RRC connection or scheduling is applied.

In order to perform RCC connection and scheduling-based data communication in 4G long term evolution (LTE) and 5G new radio (NR), UE decodes a synchronization symbol block (SSB) that a base station (BS) periodically transmits, and obtains various items of information for connecting to the wireless network of the base station on the basis of the content of the signal. In particular, when directional transmit beamforming is performed for each space by performing a repetitive transmission pattern within a predetermined temporal duration of a synchronizing signal, such as 5G NR, a user terminal should transmit a random access preamble, which corresponds to a specific beam direction of a synchronizing signal that a base station periodically and repeatedly transmits, in a RACH transmission type. Further, the terminal performs a mechanism that enables a base station to recognize an attempt to connect by a terminal only when generating preamble signals for not only a beam of a specific direction designated by a base station, but places where specific time and frequency resources are allocated, and transmitting the preamble signals to the base station.

Further, it is possible to inform a terminal of time/frequency resource information that can transmit an RACH occasion (RO) corresponding to the beam direction of a specific SSB signal of a base station, that is, a PRACH. Four-state random access (RA) defined in NR for a terminal to connect to a base station through random access for connecting to the base station is described. A four-step RA procedure can be applied to a two-step RA procedure. For example, a message MsgA may be transmitted and received in a way the same as or similar to a Msg1, and a MsgB may be transmitted and received in a way the same as or similar to a Msg2.

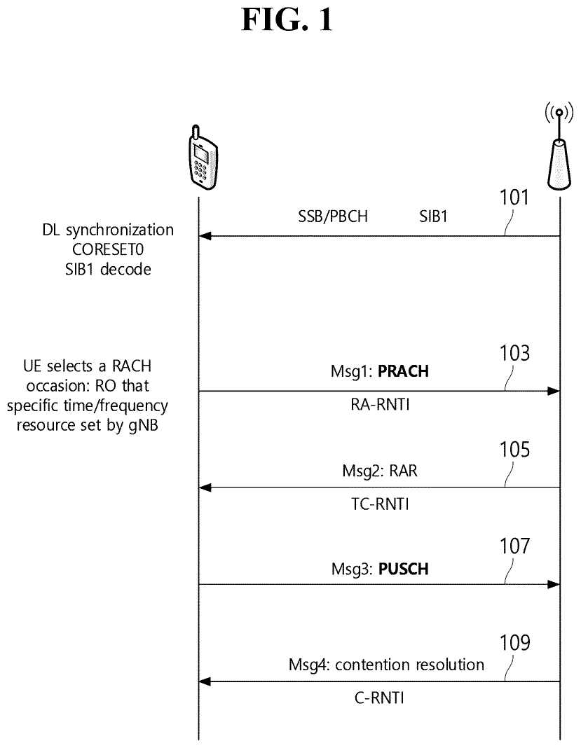

FIG. 1 shows a random access procedure according to various embodiments of the disclosure.

Referring to FIG. 1, a terminal can perform a four-step connection procedure (e.g., a four-step RA procedure) to perform initial connection.

In an operation 101, a base station can transmit SSB/PBCH and SIB 1 to a terminal. The operation 101 may be an operation of performing downlink synchronization with the base station and decoding SIB1 through CORESETO.

In an operation 103 (preamble transmission), the terminal can transmit a PRACH (e.g., an RA preamble, a random access preamble, a PRACH preamble, or Msg1) to the base station and the base station can receive the PRACH from the terminal (103). In this case, the PRACH preamble that the terminal transits may be randomly determined as one of a set of preambles determined by the base station.

Prior to the operation 103, the base station can transmit a synchronizing signal to the terminal. According to embodiment the an of present disclosure, system information may include an SSB/PBCH including SIB1.

In an operation 105 (random access response (RAR)), the base station can transmit a PDSCH (an RAR, Msg2, important timing advance (TA) information, a random access preamble ID matched with the preamble transmitted from the terminal, and an uplink grant) to the terminal, and the terminal can receive the PDSCH from the base station.

In an operation 107 (PUSCH, Msg3), the terminal can transmit a message such as RRC request and can send data through the PUSCH. The base station can receive the PUSCH from the terminal.

In an operation 109 (contention resolution), the base station can transmit a PDCCH and/or a PDSCH (Msg4) to the terminal. In this process, the base station transmits an ID to be given to the terminal so that the terminal is discriminated from other terminals and contention of uplink signals can be resolved.

The base station can transmit system information including at least one of time resource information, frequency resource information, or sequence resource information about a PRACH. The system information may include at least one of a master information block (MIB) or a system information block (SIB). The terminal can receive the system information from the base station and can obtain the time resource information, frequency resource information, and/or sequence resource information about the PRACH included in the system information. After transmitting the PRACH, the terminal can perform a monitoring operation for receiving a PDCCH (hereafter, referred to a “PDCCH monitoring operation”). The PDCCH monitoring operation may be performed in a resource domain (a time period) that is formed by a search space and a control resource set (CORESET). The terminal can perform a monitoring operation in a slot (monitoring occasion) pertaining to a RAR window to receive a RAR (msge2) from the base station.

The base station can transmit a RAR to the terminal through the PDSCH. The terminal can check an information element (information elements) included in the RAR by receiving the PDSCH including the RAR. The terminal can check whether a random access preamble identifier (RAPID) included in the RAR is the same as the RAPID of the Msg1 transmitted by the terminal. When the RAPID included in the RAR is the same as the RAPID of the Msg1 transmitted by the terminal, the terminal can perform a third step (Msg3). When a RAR including an RAPID that is the same as the RAPID of the Msg1 transmitted by the terminal is not received in a RAR window, the terminal can determine that contention has not been resolved. In this case, the terminal can again transmit a PRACH.

A RAR may include a backoff indicator (BI) field. The terminal can check a BI indicated by the RAR and can derive an upper limit value of backoff time using the BI and an appropriate scaling factor. The terminal can select a certain value between 0 and the upper limit value and can start again the RA procedure from the first step by considering the selected value as backoff time. When a

PRACH is retransmitted, the terminal can increase a retransmission counter and can increase power for retransmission of the PRACH.

A PRACH format may be classified into short PRACH formats (e.g., A1, A2, A3, B1, B2, and B3) and long PRACH formats, depending on the number of OFDM symbols to a which a PRACH preamble is mapped. The kinds of the short PRACH formats may be classified in detail, depending on the length of a cyclic prefix (CP), the length of a sequent, or the length of guard time (GT). Further, the kinds of the short PRACH formats may be classified in detail, depending on the length of a cyclic prefix (CP), the length of a sequent, and the length of guard time (GT).

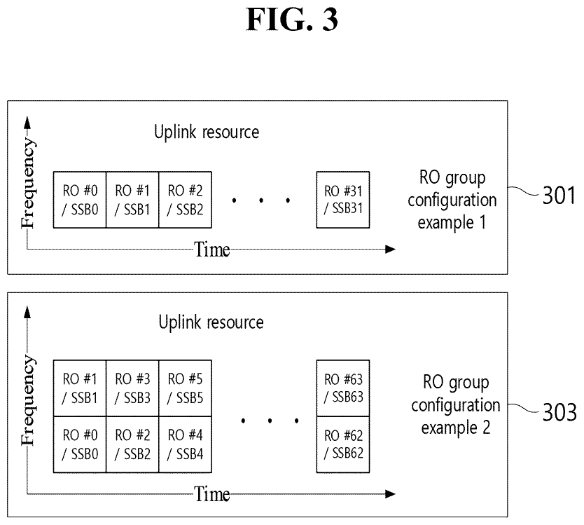

The terminal can derive a resource position of an RACH occasion (RO) corresponding to an SSB in a time domain using a PRACH configuration index. An RO corresponds to the beam direction of the base station and can be broadcasted to the terminal on the basis of RRC information through an SIB. That is, the SSB and the RO are specially mapped to correspond to each other. Such mapping is inferred through RRC parameter msg1−FDM and ssb-perRACH-OccationAndCB-PreamblesPerSSB. The RRC information may be configured to correspond to the SSB through 2D mapping. In this case, msg1−FDM (msg1−FDM=2 in the example shown in FIG. 3) means granularity of the frequency domain of PRACH signals that the terminal needs to separately transmit like reducing a temporal index instead of taking two frequency domains that can transmit a PRACH That is, the fact that a terminal selects a specific frequency and specific time at a region (RO) designated by a base station and transmits a PRACH means that one specific transmission SSB beam index of the base station was received with highest quality to the terminal.

That is, when reception of a PRACH is detected in a time/frequency domain designated by a base station, the base station recognizes a specific downlink transmission beam direction as a beam pattern with which a terminal easily receives a downlink signal (that is, a beam direction that is scheduled). For example, when a terminal determines SSB3 is the most suitable reception downlink beam direction, the terminal has to transmit a PRACH signal to a time/frequency uplink resource designated as RO#3.

### [Method of Extending Reach Area of PRACH]

[1a. Method of Using Spatial Dimension]

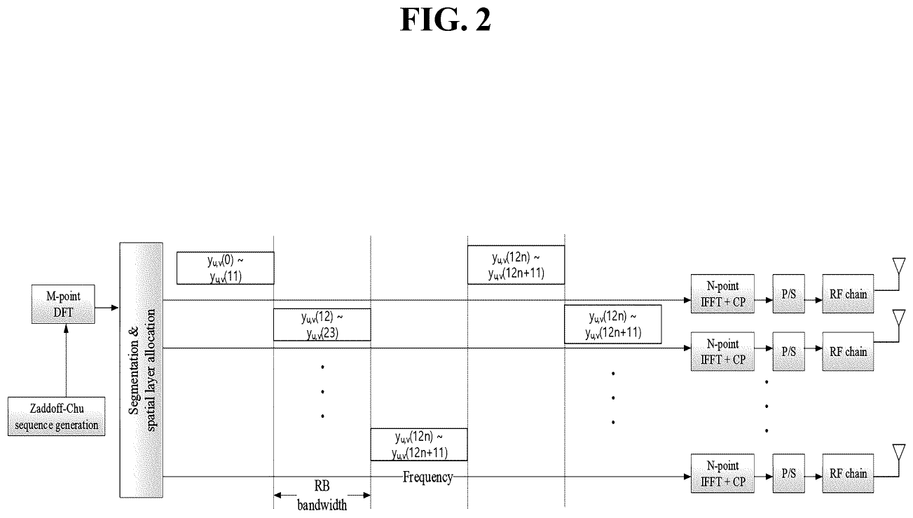

FIG. 2 is a block diagram showing a transmission end of a terminal according to an embodiment of the present disclosure. FIG. 2 shows a transmission method through extension of a spatial domain for extending a reach area in step msg1 and shows a signal transmission method of a PRACH preamble through certain sequence allocation in a frequency domain when msg1 is transmitted.

Referring to FIG. 2, transmission sources for each frequency domain may depend on the number of multiple panels or the number of ports. Even though several panels, several ports, or both of the types are applied, a PRACH signal can be generated in a frequency domain and can be repeatedly generated and transmitted for each panel and port. That is, even though PRACH signals are generated in a frequency domain and transmitted in a time domain simultaneously at several transmission panels or ports, a base station can perform demodulation. However, the PRACH signals transmitted to the panels or the ports may be transmitted to the base station while having different wireless s channels. Accordingly, when PRACH signals are simultaneously transmitted to several panels or ports, the base station receives a PRACH signal that has undergone a wireless channel generated by combination in a composite type.

When a terminal performs transmission simultaneously at several panels or ports, the terminal has to distribute power by the number due to a limitation in maximum total transmission power by radio regulation. That is, when a PRACH is transmitted while power is uniformly distribute to panels or ports, a wireless channel applied at a specific panel or port is greatly influenced by fading or path-loss, efficient transmission is not achieved, so it may mean that the reception SNR of a base station is deteriorated, but when the influence by fading and path-loss is small, an opposite case occurs. For example, when PRACH signals are transmitted to two panels, a half of the total transmission power is allocated and sent to each panel, and a PRACH signal undergoing a deep fading wireless channel and a PRACH signal undergoing a light fading wireless channel are mixed on a frequency axis, so a base station receives a signal that has passed through a wireless channel corresponding to the medium of the deep fading and the light fading.

Accordingly, in the case in which a terminal transmits a PRACH to a base station, when the terminal has, in advance, information that it is possible to transmit the PRACH to a good uplink wireless channel, the reach area increases, but it is limited to know that in advance. In particular, in an FDD system, it is difficult to know the state of the wireless channel of advantageous uplink corresponding to each panel or port due to an asymmetric characteristic of uplink and downlink. Accordingly, it is possible to apply open loop transmission diversity on a frequency axis and it is possible to apply a way of mapping specific frequency domain, panel, and port and performing transmission. Such PRACH transmission may be considered as sparse frequency transmission for each space. That is, sparsity of a frequency domain is increased in proportion to the number of transmission panels and the number of ports on the panel's or port's part. It is characteristic issue that since power is allocated and sent to only a specific RB for each RF chain and the others are void, it is possible to concentrate the transmission power allocated to panels and ports. That is, power per RB increases, so the signal to noise ratio (SNR) of a detection receiver of a base station can increase.

A PRACH signal can be generated in a frequency domain on the basis of a Zaddoff-Chu (ZC) sequence signal. According to an embodiment, in NR of a transmission end, the length of a ZC sequence in a frequency domain may be 139 or 839 or 1151 or 571. The lengths of ZC sequences may be allocated to a frequency domain through several resource blocks RB by numerology of a physical layer. A basic Zaddoff-Chu sequence is determined by a physical root sequence index #, and a sequence having the following length L_{RA} is generated (Equation 1).

$${x}_{u} ( i ) = {e}^{- j \frac{π ui ( i + 1 )}{{L}_{RA}}} , i = 0 , 1 , … , {L}_{RA} - 1 \qquad [ Equation 1 ]$$

The following Equation 2 can be obtained by applying Cyclic shift Cv to Equation 1.

$${x}_{u , v} ( n ) = {x}_{u} ( ( n + {C}_{v} ) mod {L}_{RA} ) \qquad [ Equation 2 ]$$

Further, when Equation 2 is converted to a frequency domain, it can become Equation 3.

$${y}_{u , v} ( k ) = {\sum }_{m = 0}^{{L}_{RA} - 1} {x}_{u , v} ( m ) \cdot {e}^{- j \frac{2 π mk}{{L}_{RA}}} \qquad [ Equation 3 ]$$

In this case, Equation 4 and Equation 5 can be defined such that a portion of a sequence y_{u,v}(k) can be transmitted only at one panel or port Pₘ sequentially for each RB.

$${p}_{m} = {RB}_{kp} mod M , m = 0 , 1 , … , M - 1 \qquad [ Equation 4 ]$$

$$kp = 0 , 1 , … , \frac{{L}_{RA} + GB}{{L}_{RB}} \qquad [ Equation 5 ]$$

In Equation 4 and Equation 5, RBₖₚ is the kp-th index corresponding to the frequency domain resource block of a transmission end. It is assumed that there are a total of M transmission panels or ports Pₘ, and they are identified by an index m. GB is a guide band. That is, a portion of a PRACH sequence of the frequency domain corresponding to a specific RB is sequentially mapped to corresponding panels or ports in accordance with an increasing order. Accordingly, when a PRACH sequence is not mapped to a corresponding panel or port, it is configured as a void signal in a frequency domain. That is, power of 1/M is allocated to one selected panel or port in terms of allocation of transmission power or energy per RB domain.

As shown in FIG. 2, a Zaddoff-Chu sequence can be converted in a frequency domain through M-point DFT. The converted sequence is allocated to several panels or ports through scrambling and spatial layout allocation. Each panel or port transmit a portion of the sequence allocated to a specific RB, and in this process, several items of inverse Fast Fourier Transform (N-point IFFT) and multiple Cyclic Prefixes (CP) are applied and a signal is transported. In this process, a signal is finally transmitted to an antenna through P/S (parallel-serial conversion) and an RF chain.

[1b. Method of Using Pre-Defined Time Domain Multiple Transmission]

A method of extending a: reach area by applying multiple transmission in a time domain is described. When a PRACH 1 is transmitted several times in a time domain, it should be discriminated from an existing signal case of a terminal attempting to transmit PRACH at a time, and, in multiple transmission, a base station has to be able to track the order of the number of times of corresponding transmission in order not to unnecessarily transmit msg3 RAR (in this case, it is assumed that when the base station detects at the early stage a PRACH signal of the terminal attempting multiple PRACH transmission, the base station receives all of multiple PRACHs and notifies of msg3 RAR without immediately responding). When transmitting several PRACHs, it is possible to consider application of same sequence (configuration) to the PRACHs (in consideration of the point that it is easy to discriminate from single PRACH transmission). According to an embodiment, setting the number of times of temporal multiple transmission as about {2, 4, 8} may be considered.

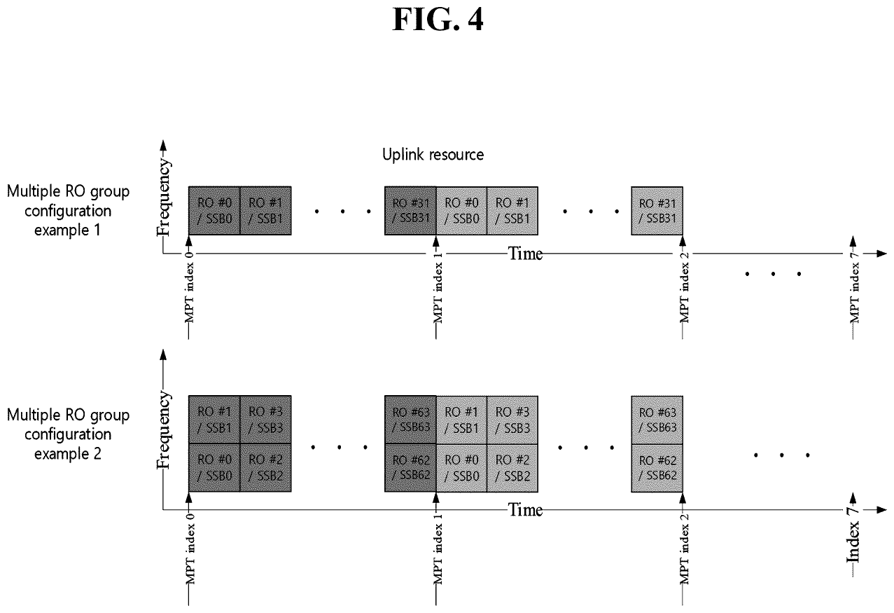

Accordingly, it is possible to approach a method for discriminating multiple PRACH transmission and signal PRACH transmission in two points in a broad meaning (FIGS. 3 and 4).

FIG. 3 shows an example of resource allocation relating to mapping of an SSB beam index and an RO resource designated to transmit multiple PRACHs in accordance with an embodiment of the present disclosure. That is, FIG. 3 relates to a method of newly determining a method of mapping an SSB beam index and an RO resource designated to transmit multiple PRACHs.

Referring to FIG. 3, it may mean that the kind of a PRACH preamble defined before is not newly defined and used as it is. A newly defined uplink RO resource (RO group) for multiple PRACH transmission may not overlap an existing uplink RO resource for single PRACH designation.

In an RO group configuration example 1 that is the box 301, the case in which uplink resources were allocated to respective SSB indexes on frequency and time axes from RO#0 to RO#31 is shown. This shows that each RO has been mapped to a specific SSB index. For example, RO#0 may be mapped to SSB0 and RO#1 may be mapped to SSB1.

An RO group configuration example 2 that is the box 302 shows that uplink resources were allocated to respective SSB beam indexes from RO#0 to RO#63. For example, each RO is mapped to a specific SSB beam index. RO#0 may be mapped to SSB0 and RO#1 may be mapped to SSB1. This configuration shows an example of resource allocation for multiple PRACH transmission.

FIG. 4 shows another example of resource allocation relating to mapping of an SSB beam index and an RO resource designated to transmit multiple PRACHs in accordance with an embodiment of the present disclosure.

Referring to FIG. 4, when an existing RO resource for single PRACH transmission overlaps an RO group for multiple PRACH transmission, it is required to be able to discriminate a single PRACH uplink transmission signal and a multiple PRACH transmission uplink signal when simultaneously receiving them. This is because it is possible to count transmission trial of a corresponding signal only when determining the order of multiple PRACH transmission.

A first method of allocating separate uplink RO resources for transmitting multiple PRACHs through time extension uses an existing PRACH preamble format as it is, and maps separate time/frequency resources to beam indexes, so ROs are separately designated, but they can be designated into an RO group due to multiple transmission. As in FIG. 4, there are 64 Tx beam indexes, the index of an RO group is designated in accordance with the total number of multiple PRACH transmission and the RO group that is the start point becomes the first index in repetitive transmission. For example, as in FIG. 4, it may be possible to apply a method that enables a base station discriminates indexes of multiple PRACH transmission (MPT) of a terminal by notifying of an RO group to separate (different from single PRACH transmission) uplink time/frequency domains, which are notified of to a terminal attempting repetitive transmission eight times at an SIB, and that indicates the time indexes of the multiple transmission from the first to the eighth to the SIB. The temporal interval between a start point, at which the index of the RO group becomes 0 in accordance with the total number of multiple transmission, and a point in time at which it increases can be freely determined as a multiple of the unit of slot or the unit of frame in the base station. Further, it is possible to designate an interval set in accordance with the total number of multiple transmission. Accordingly, when a terminal decides multiple PRACH transmission, the terminal can be implicitly and explicitly informed of information that can determine end time of repetitive transmission from MPT index 0 from the base station through an SIB. Further, an uplink PO resource of a set of preambles corresponding to an SSB at every predetermined time (slot/frame) period in previous single PRACH transmission can be set as a cycle at the same period in multiple PRACH transmission.

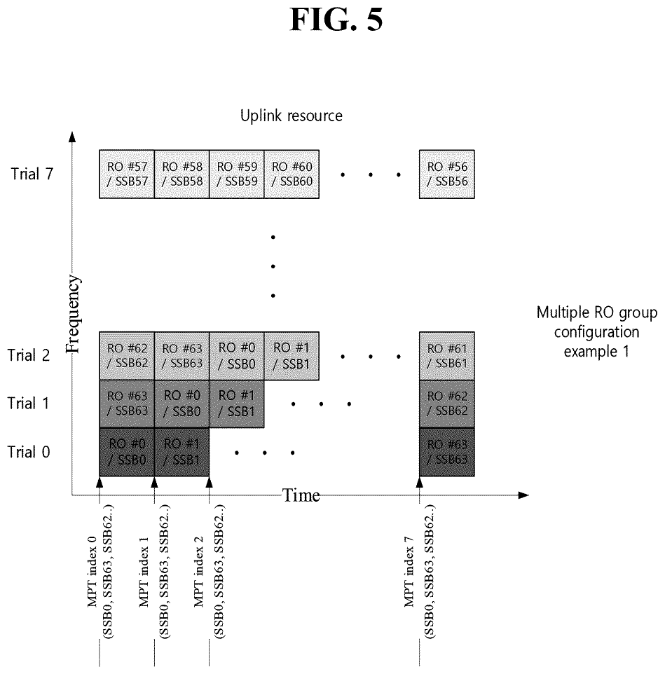

As the method of extending time, it is possible to apply a method of designating an RO group through extension to a frequency domain other than determining an MPT index. It is possible to reduce temporal latency of PARCH transmission by further using a frequency domain instead of reducing time extension, as in FIG. 5. However, the order of an MPT index may be determined on the basis of the number of an SSB beam. FIG. 5 shows an embodiment of temporal time inference of an MPT index based on SSB #0. In this case, the index 0 may show a time/frequency domain corresponding to first of trial PRACH repetitive transmission of a terminal and the index 1 may indicate a second time/frequency domain. Accordingly, when SSB #3 is a reference, it may be mapped as time/frequency source information of the first transmission point of PRACH repetitive transmission after 2 time indexes temporally from SSB #0. That is, it is possible to apply a case of recognizing a frequency domain as a trial index of repetitive transmission. Further, it is possible to define variable 2 dimensional SSB-to-RO group mapping by applying an extending domain not only to a frequency, but a time domain in accordance with a total number of multiple PRACH transmission trials. Further, an uplink RO resource of a set of preambles corresponding to an SSB at every predetermined time (slot/frame) period in previous single PRACH transmission may be set as a cycle at the same period in multiple PRACH transmission.

A second method for discriminating multiple PRACH transmission from single PRACH transmission without allocating/designating specific time/frequency to perform multiple PRACH transmission through time extension is described. This is a method of using SSB-to-RO mapping designated in previous single PRACH transmission at it is, but defining/designating a sequence for separate multiple PRACH preambles for multiple PRACH transmission and notifying of the sequence by means of a base station.

A reserved PRACH preamble sequence may be selected. Further, a reserved sequence that can show indexes 0 to 7 may be designated. Further, other than the method of an existing defined and reserved sequence, it is possible to apply a method of defining a new Zaddoff-Chu shift value or a root sequence to a sequence.

### [Method of Extending Reach Area of PUSCH]

Uplink data transmission is designated to a physical uplink shared channel (PUSCH) and a PRACH signal is composed of only one Zaddoff-Chu sequence, but a PUSCH signal is composed of a demodulation reference signal for symbol demodulation and a modulated symbol to which channel coding has been applied.

A PUSCH may mean a message A PUSCH rather than an msg3 PUSCH or an RA step in an initial connection procedure. In order to extend a UL coverage, a base station can instruct a terminal to allocate high transmission power to a PUSCH. Alternatively, in order to extend a UL coverage, the number of times of transmission of a PUSCH (e.g., a time resource) may be increased. When a PUSCH is repeatedly transmitted, it is possible to widen a reach area by allocating high power in a narrow band.

A base station can instruct a terminal to allocate high power of a PUSCH signal or perform repetitive transmission through RAR in step msg2 using system information or upper layer signaling.

Further, it is possible to apply a method of extending a PRACH reach area using spatial freedom to a PUSCH, as in FIG. 2. In this case, (y_{u,v}(0˜11), (y_{u,v}(12˜23), . . . etc.) that are a portion of a PRACH sequence corresponding to a portion of a codeword and a DMRS is also divided for each spatial layer. That is, a terminal can allocate more power to increase a reach distance by reducing a PAPR of a PUSCH signal without being specifically instructed by a base station.

FIG. 5 shows an example of resource allocation for extending a reach area of a PUSCH in accordance with an embodiment of the present disclosure.

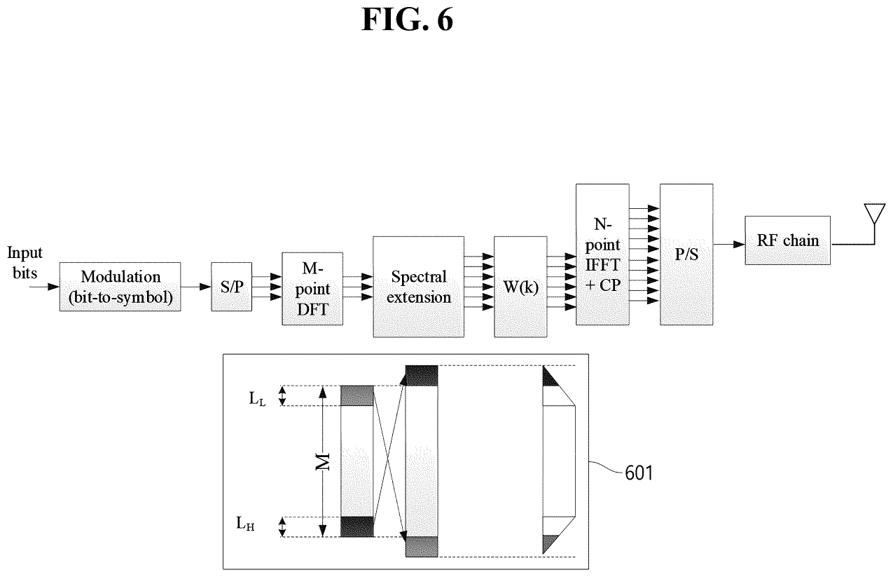

Referring to FIG. 5, it is possible to process a PUSCH signal of a terminal to have a low PAPR value by applying DFT transform precoding at the transmission end of the terminal, applying spectra extension, and applying filtering such as windowing, so it is possible to transmit msg3 and msgA signals by applying higher power. In this case, the spectral extension is to give a cyclic type by extending a low frequency signal domain L_{L} and a partial domain L_{H} of a low frequency of the result of a signal made in a frequency domain by applying M-point DFT to data of a time domain such that the domains cross each other, as in FIG. 6. In this case, the type of applying a DFT transform precoding by mapping a symbol in the unit of RB in an existing PUSCH by spectral extension should be changed. That is, it is required to implement spectral extension in a frequency domain through two methods. The first one is a method of making the number of data symbols to be transmitted smaller than the unit of RB and adding frequency domain symbols of a signal to which M-point DFT has been applied and E (E=L_{L}+L_{H}) symbols into the unit of RB and a method in which an existing M-point is the same as the unit of RB and a E domain is transmitted out of a designated transmission band. The length of E is not limited for spectral extension, but it may be determined as a percentage to the number of total resources of an RB.

Since spectral extension is applied, time separation between symbols in a time domain after IFFT increases and the pulse of each symbol less influences an adjacent symbol, so the magnitude of a signal that is superposed decreases, and accordingly, a PAPR decreases. Filtering/windowing in a frequency domain also have influence in relation to a PAPR in a time domain. When a frequency domain has a perpendicular shape, peaks having a sinc pulse in a time domain are generated outside a center point domain. In order to reduce the size of residual peaks in a time domain, when spectral shape is performed in a frequency domain or low pass filtering is performed in a time domain, residual peaks in the time domain can be suppressed, so the PAPR decreases.

FIG. 6 shows an example of a block diagram for spectrum shaping according to an embodiment of the present disclosure.

A filter function can be defined, as in Equations 6 to 9, for a windowing function that is applied to a frequency domain through spectral shaping, as in FIG. 6.

$$\begin{matrix}W ( k ) = G ( k ) , & 0 \leq k \leq 2 {L}_{L} - 1\end{matrix} \qquad [ Equation 6 ]$$

$$\begin{matrix}W ( k ) = 1 , & 2 {L}_{L} \leq k \leq {L}_{L} + M - {L}_{H} - 1\end{matrix} \qquad [ Equation 7 ]$$

$$\begin{matrix}W ( k ) = G ( k - M + 2 {L}_{H} - 1 ) , & {L}_{L} + M - {L}_{H} \leq k \leq M + {L}_{H} - 1\end{matrix} \qquad [ Equation 8 ]$$

$$G ( k ) = \frac{1}{2} ( 1 - cos \frac{π k}{{L}_{H} + {L}_{L} - 1} ) \qquad [ Equation 9 ]$$

where k is a unit index corresponding to one subcarrier spacing of a frequency domain.

Referring to FIG. 6, an input bit can be converted into a bit-symbol through modulation. The converted symbol can be converted into a frequency domain through M-point DFT by parallel-serial conversion. A signal of the converted frequency extends domain through spectral extension and then a windowing function is applied to the signal. Thereafter, the signal is converted into a time domain through IFFT and a CP and can be finally transmitted to an antenna through an RF chain after parallel-serial conversion.

A spectral shaping process of a windowing function is visually shown in the box 601. Filtering is applied at a low band L_{L} and a high band L_{H} in a frequency domain and an original signal can be maintained in a middle band M. It is possible to generate a signal having desired bandwidth and shape by adjusting a spectrum shape in a frequency domain through such as windowing function.

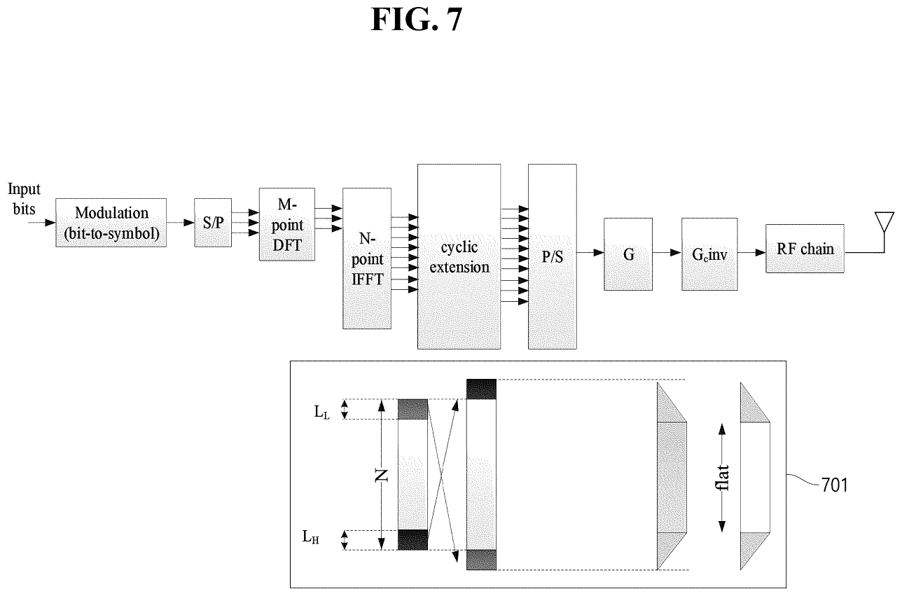

FIG. 7 shows another example of a block diagram for spectrum shaping according to an embodiment of the present disclosure.

Referring to the figure, even by applying low pass filtering in a time domain after IFFT, it is possible to achieve spectral shaping and it is possible to define the following finite impulse response (FIR) filter.

$$g ( t ) = \frac{1}{{2}^{n}} {( 1 + {t}^{- 1} )}^{n} \qquad [ Equation 10 ]$$

[symbol] t where t is the unit of sample in a time domain.

Filtering is applied to a low pass filter g(t) through convolution, but it is possible to change to an equivalent convolution operation through a matrix operation by converting g(t) into G of Toeplitz matrix type instead of a convolution operation. In this case, IFFT output is converted into a diagonal matrix type to apply a matrix operation. An operation with the converted matrix G is applied to the entire output range N+L_{L}+L_{H} of IFFT and then an inverse matrix (i.e., a matrix about the middle region N-L_{L}-L_{H} of the same part as the IFFT output) can be applied as G_{c}inv that makes only the N-L_{L}-L_{H} region into diagonal matrix. G_{c}inv When G_{c}inv is applied, the self intersymbol interference (ISI) of a flat part is removed, so it is possible to increase the reliability of a signal.

Referring to FIG. 5, input bits can be converted into a bit-to-symbol through modulation. The converted symbol can be converted into a frequency domain through M-point Discrete Fourier Transform (DFT) by serial-parallel (S/P) conversion. A signal of the converted frequency domain is converted into a time domain through N-point Inverse Fast Fourier Transform (IFF) and cyclic extension, undergoes parallel-serial (P/S) conversion, and then can be filtered through Toeplitz matrix G and G inv to apply low pass filtering. The filtered signal can be finally transmitted to an antenna through an RF chain.

A spectral shaping process of a windowing function is visually shown in the box 701. Filtering is applied at a low band L_{L} and a high band L_{H} in a frequency domain and an original signal is maintained in a middle band M. It is possible to generate a signal having desired bandwidth and shape by adjusting a spectrum shape in a frequency domain through such as low pass filtering. IFFT output is converted into a diagonal matrix type and operated with a matrix G and the ISI of the middle band is removed through G inv, thereby increasing the reliability of a signal.

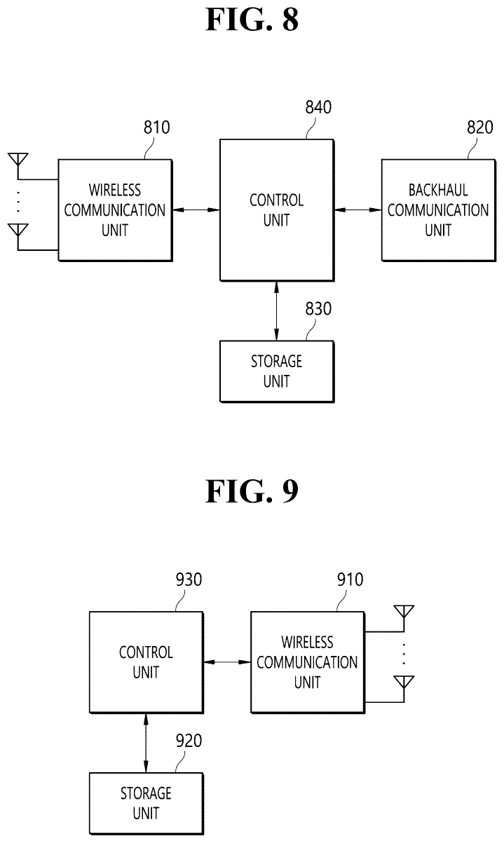

FIG. 8 is a configuration diagram of a base station in a wireless communication system according to various embodiments of the disclosure. The configuration exemplified in FIG. 8 may be understood as the configuration of a base station. Terms ‘ . . . unit’, ‘ . . . er’ used hereafter mean the unit for processing at least one function or operation and may be implemented by hardware, software, or a combination of hardware and software.

Referring to FIG. 8, a base station may include a wireless communication unit 810, a backhaul communication unit 820, a storage unit 830, and a control unit 840.

The wireless communication unit 810 can transmit and receive a wireless signal through a wireless channel. For example, the wireless communication unit 810 can perform a conversion function among baseband signals and bit strings in accordance with the physical layer specification of a system. Further, the wireless communication unit 810 can generate complex symbols by encoding and modulating a transmission bit string when transmitting data. When receiving data, the wireless communication unit 810 can recover a received bit string by demodulating and decoding a baseband signal.

The wireless communication unit 810 can up-convert baseband signals into radio frequency (RF) band signals and then transmit the converted signals through an antenna, and can down-convert RF band signals received through the antenna into baseband signals. To this end, the wireless communication unit 810 may include a transmission filter, a reception filter, an amplifier, a mixer, an oscillator, a digital to analog converter (DAC), an analog to digital converter (ADC), etc.

The wireless communication unit 810 may include several transmission and reception paths and may include at least one antenna array composed of several antenna elements.

In terms of hardware, the wireless communication unit 810 may include a digital unit and an analog unit, in which the analog unit may include a plurality of sub-units, depending on the operation power, operation frequency, etc. The digital unit may be implemented as at least one processor (e.g., a digital signal processor (DSP)).

The wireless communication unit 810 can transmit and receive a wireless signal, as described above. Accordingly, the wireless communication unit 810 may be entirely or partially referred to as a ‘transmitter’, a ‘receiver’, or a ‘transceiver’. Further, in the following description, transmission and reception that are performed through wireless channels may include performance of the above-mentioned processing by the wireless communication unit 810.

The backhaul communication unit 820 can provide an interface for communication with other nodes in a network. That is, the backhaul communication unit 820 converts bit stings that are transmitted from the base station to another node, for example, another connection node, another base station, an upper node, and a core network, into physical signals, and converts physical signals received from another node into bit strings.

The storage unit 830 can store data such as fundamental programs, applications, and setting information for operation of the base station. The storage unit 830 may be a volatile memory, a nonvolatile memory, or a combination of a volatile memory and a nonvolatile memory. Further, the storage unit 830 can provide stored data in response to a request from the control unit 840.

The control unit 840 can control general operations of the base station. For example, the control unit 840 can transmit and receive signals through the wireless communication unit 810 or the backhaul communication unit 820. Further, the control unit 840 can record and read data on and from the storage unit 830. Further, the control unit 840 can perform the functions of a protocol stack required by communication standards.

To this end, the control unit 840 may include at least one processor.

According to various embodiments of the disclosure, the control unit 840 can perform control to perform operations according to various embodiments that are performed by the base station.

FIG. 9 is a configuration diagram of a terminal in a wireless communication system according to various embodiments of the disclosure. The configuration exemplified in FIG. 9 may be understood as the configuration of a terminal. Terms ‘ . . . unit’, ‘ . . . er’ used hereafter mean the unit for processing at least one function or operation and may be implemented by hardware, software, or a combination of hardware and software.

Referring to FIG. 9, a terminal may include a communication unit 910, a storage unit 920, and a control unit 930.

The communication unit 910 can perform functions for transmitting/receiving signals through wireless channels. For example, the communication unit 910 can perform a conversion function among baseband signals and bit strings in accordance with the physical layer specification of a system. For example, the communication unit 910 can generate complex symbols by encoding and modulating a transmission bit string when transmitting data. When receiving data, the communication unit 910 can recover a received bit string by demodulating and decoding a baseband signal. Further, the communication unit 910 can up-convert baseband signals into RF band signals and then transmit the converted signals through an antenna, and can down-convert RF band signals received through the antenna into baseband signals. For example, the communication unit 910 may include a transmission filter, a reception filter, an amplifier, a mixer, an oscillator, a DAC, an ADC, etc.

Further, the communication unit 910 may include several transmission/reception paths. Further, the communication unit 910 may include at least one antenna array composed of several antenna elements. In terms of hardware, the communication unit 910 may be composed of a digital circuit and an analog circuit (for example, a radio frequency integrated circuit (RFIC)). In this case, the digital circuit and the analog circuit may be implemented in one package. Further, the communication unit 910 may include several RF chains. Further, the communication unit 910 can perform beamforming.

The communication unit 910 transmits and receives signals, as described above. Accordingly, the communication unit 910 may be entirely or partially referred to as a ‘transmitter’, a ‘receiver’, or a ‘transceiver’. Further, transmission and reception that are performed through wireless channels may be used as meanings that include the above-mentioned processing performed by the communication unit 910.

The storage unit 920 can store data such as fundamental programs, applications, and setting information for operation of the terminal. The storage unit 920 may be a volatile memory, a nonvolatile memory, or a combination of a volatile memory and a nonvolatile memory. Further, the storage unit 920 can provide stored data in response to a request from the control unit 930.

The control unit 930 can control general operations of the terminal. For example, the control unit 930 can transmit and receive signals through the communication unit 910. Further, the control unit 930 can record and read data on and from the storage unit 920. The control unit 930 can perform the functions of a protocol stack required by communication standards. To this end, the control unit 930 may include at least one processor or microprocessor, or may be a part of a processor. A portion of the communication unit 910 and the control unit 930 may be referred to as a communication processor (CP).

According to various embodiments of the disclosure, the control unit 930 can perform control to perform operations according to various embodiments that are performed by the terminal.

Methods according to the claims or the embodiments described in the specification may be implemented in the type of hardware, software, or a combination of software and hardware.

When they are implemented in software, a computer-readable storage medium that stores one or more programs (software modules) may be provided. The one or more programs stored in the computer-readable storage medium are configured for execution by one or more processors in an electronic device. The one or more programs include instructions for the electronic device to perform the methods according to the claims of the disclosure or embodiments described in the specification.

Such programs (software modules, software) may be stored in a nonvolatile memory including a random access memory and a flash memory, a Read Only Memory (ROM), an Electrically Erasable Programmable Read Only Memory (EEPROM), a magnetic disc storage device, a Compact Disc-ROM (CD-ROM), Digital Versatile Discs (DVDs), or another type of optical storage device, and a magnetic cassette. Alternatively, they may be stored in a memory configured by combining some or all of the devices. Each configuration memory may be included as several pieces.

The programs may be stored in an attachable storage device that can be accessed through a communication network such as the internet, an intranet, a Local Area Network (LAN), a Wide Area Network (WAN), or a Storage Area Network (SAN), or a network configured by combining them. The storage device can access a device that performs embodiments of the disclosure through an external port. A separate storage device in a communication network can access a device that performs the embodiments of the disclosure.

In the detailed embodiment of the disclosure described above, the components included in the disclosure were described in singular forms or plural forms, depending on the proposed detailed embodiments. However, the singular or plural expressions were appropriately selected in the proposed situations for the convenience of description and the disclosure is not limited to the singular or plural components. Further, even if components are described in a plural form, they may be singular components, or even if components are described in a singular form, they may be plural components.

Although detailed embodiments were described above, various modifications are possible without departing from the scope of the disclosure. Accordingly, the range of the disclosure is not limited to the embodiments and should be defined by not only the range of the claims described below, but also equivalents to the range of the claims.

What is claimed is:

1. An operation method of a transmitter in a wireless communication system, the operation method comprising:
generating sequences for generating a physical random preamble channel (PRACH) signal;
converting the sequences in a frequency domain;
dividing the converted sequences into frequency source blocks (RB);
allocating the frequency resource blocks to different spatial layers; and
transmitting the PRACH signal on the basis of the frequency resource blocks allocated to the spatial layers.

2. The operation method of claim 1, wherein the dividing the frequency resource blocks comprises allocating the frequency resource blocks to different transmission antenna ports, respectively.

3. The operation method of claim 1, wherein the transmitting the PRACH signal comprises repetitively transmitting the PRACH signal with predetermined time intervals, and forms an RO group, and uses time indexes in the RO group to recognize the repetitive transmission.

4. The operation method of claim 3, wherein the time indexes comprise an index for recognizing first repetitive transmission of a starting RO (starting random access channel (RACH) occasion) group.

5. The operation method of claim 3, wherein the time indexes are transmitted through a control signal.

6. The operation method of claim 1, wherein the transmitting the PRACH signal comprises allocating indexes for repetitive transmission of the PRACH signal in the frequency domain.

7. The operation method of claim 6, wherein the indexes for repetitive transmission of the PRACH signal are allocated on the basis of allocation positions of the frequency resource blocks, and
a repetitive transmission order of the PRACH signal is determined on the basis of the allocation positions of the frequency resource blocks.

8. The operation method of claim 6, wherein the indexes in the RO group for repetitive transmission of the PRACH signal are allocated to time allocation positions having priority to the allocation positions of the frequency resource blocks, and
a repetitive transmission order of the PRACH signal is determined on the basis of the frequency and allocation positions of time resource blocks.

9. An operation method of a transmitter in a wireless communication system, the operation method comprising:
applying a spectrum shaping filter to a physical uplink shared channel (PUSCH) signal in a frequency domain;
reducing a peak-to-average power ratio (PAPR) by filtering the PUSCH signal through a finite impulse response (FIR) filter in a time domain; and
transmitting the FIR-filtered PUSCH signal.

10. The operation method of claim 9, wherein the spectrum shaping filter is applied in a frequency domain to compensate for frequency selective fading.

11. The operation method of claim 9, wherein the FIR filter is applied to a time domain to compensate for another path fading.

12. A transmitter of a wireless communication system, the transmitter comprising:
a transceiver; and
a control unit operably connected to the transceiver,
wherein the control unit
generates sequences for generating a physical random preamble channel (PRACH) signal,
converts the sequences in a frequency domain,
divides the converted sequences into frequency source blocks (RB),
allocates the frequency resource blocks to different spatial layers, and
transmits the PRACH signal on the basis of the frequency resource blocks allocated to the spatial layers.

13. The transmitter of claim 12, wherein the control unit allocates the frequency resource blocks to different transmission antennas, respectively, to divide the frequency resource blocks.

14. The transmitter of claim 12, wherein the control unit repetitively transmits the PARCH signal with predetermined time intervals to transmit the PRACH signal, and uses time indexes to recognize the repetitive transmission.

15. The transmitter of claim 14, wherein the time indexes comprise an index for recognizing first repetitive transmission of a starting RO (starting random access channel (RACH) occasion) group.

16. The transmitter of claim 14, wherein the time indexes are transmitted through a control signal.

17. The transmitter of claim 12, wherein the control unit performs a process of allocating indexes for repetitive transmission of the PRACH signal in the frequency domain to transmit the PRACH signal.

18. The transmitter of claim 17, wherein the indexes for repetitive transmission of the PRACH signal are allocated on the basis of allocation positions of the frequency resource blocks, and
a repetitive transmission order of the PRACH signal is determined on the basis of the allocation positions of the frequency resource blocks.

19. The operation method of claim 7, wherein the indexes in the RO group for repetitive transmission of the PRACH signal are allocated to time allocation positions having priority to the allocation positions of the frequency resource blocks, and
a repetitive transmission order of the PRACH signal is determined on the basis of the frequency and allocation positions of time resource blocks.
